(19) United States
(12) Patent Application Publication
(10) Pub. No.: US 2018/0064038 A1
(43) Pub. Date: Mar. 8, 2018

(54) Mobile Trellis

(71) Applicant: Matthew Louis Niccoli, Fort Collins, CO (US)

(72) Inventor: Matthew Louis Niccoli, Fort Collins, CO (US)

(21) Appl. No.: 15/258,037

(22) Filed: Sep. 7, 2016

(51) Int. Cl. A01G 9/12; A01G 1/00

(52) U.S. Cl. CPC A01G 9/12; A01G 1/001

(57) ABSTRACT

A mobile plant trellis structure for providing support and optimal light exposure during plant growth. The plant trellis structure includes one or two horizontal grids that slide along vertical support states. The frame of the horizontal grid structure is configured from wood, PVC piping or light weight metals. The vertical support stakes are configured from steel core plastic rods or wood. Shapes of the horizontal grids include square, round, hexagon, and so forth. Trellis structure will move up and down and be set for optimum height for plant health. A group of 4 are placed together for a single light source.

### BACKGROUND OF THE INVENTION

The present invention relates to plant support systems for optimizing growth and health of growing plants.

Trellis structures, often made from interwoven pieces of wood, bamboo, plastic or metal are common providing support for climbing plants and vines. These trellises are typically generally planar, fence-like structures and can be decorative. In potted confinement plants can flourish such that their leaves and blossoms extend out beyond the size of the pot and spread excessively. Here trellis structures are also common for supporting such plant foliage and redirecting the growth upward. Additionally, both with potted plants and outdoor gardening, it is often desirable to add structural support to unstable growing plants to support heavy vegetation, blooming flowers, fruits, or vegetables, such as for peonies or tomato plants. Various plants have large, heavy blooms where the weight of the flower needs to be supported above the ground, and various plants can produce heavy fruits or vegetables which benefit from support above the ground. It is often desirable to support the plant stalks and blooms or fruit to protect them from damage due to insects, dirt or from contact with the ground. It is also beneficial to support the blooms or fruit up higher off the ground so they are more visible to sunlight or artificial light. Cannabis plants grown in indoor grow houses have specific needs for optimal growth including temperature, light, water, support, carbon dioxide levels and humidity conditions. Conventional trellises can help with support issues but are not optimized for cannabis support and maximum light exposure. Generally, existing planar trellises are not readily adaptable for such purposes. Known circular plant supports tend to be made of thin, light-weight, one-piece wire construction and cannot be easily installed or adjusted once the plant is large. Existing circular trellises for potted plants tend to bunch the plant together while supporting the unstable plant. This can provide poor light exposure to the majority of the plant's leaves. There is a need for a way to provide an adjustable support for unstable plants such as cannabis generally while also maximizing light exposure to encourage optimum growth.

### SUMMARY OF THE INVENTION

A trellis support device is disclosed according to one embodiment of the present invention. The trellis support device is height adjustable for optimal support of plants with a planer grid used to hold stalks in place. In one embodiment the planar grid is adjustable to wide openings such that plant stocks, branches and leaves are able to slide through planar grid and then later adjustable to narrow openings such that plant stocks are supported. In another embodiment the trellis support device also includes first and second planar grids configured to surround and support plants at two different points. The two planar grid trellis devices are then also height adjustable and tuned to optimize plant health and growth. In both embodiments the planar grid or grids can move automatically upward with the growth of the plant. Mounting legs of the subassemblies are pressed into a supporting material, such as soil, thereby retaining the trellis support device in a desired stable position with the legs generally vertical. The planar grid or grids may extend out further than the pot in which the plant is growing. Here the diameter of the pot is smaller than the diameter or size of the trellis grid such that the plants branches and leaves are spread laterally to obtain additional light exposure. Therefor this trellis may be used to form a structurally supported growth area for unstable or climbing plants and vines while optimizing light exposure.

### BRIEF DESCRIPTION OF THE DRAWINGS

Various embodiments of the invention, together with its objects and advantages may be better understood by reference to the following detailed description taken together with the accompanying drawings wherein:

FIG. 1 is a drawing of one planar trellis grid including trellis wire and frame;

FIG. 2 is an alternate shape for the trellis grid;

FIG. 3a is a three dimensional depiction of the invention including supporting poles or stakes;

FIG. 3b is a drawing showing supporting pole clamps;

FIG. 4 is an embodiment with two planar support grids

FIG. 5 is a drawing showing trellis placement with lamps.

### DETAILED DESCRIPTION OF THE INVENTION

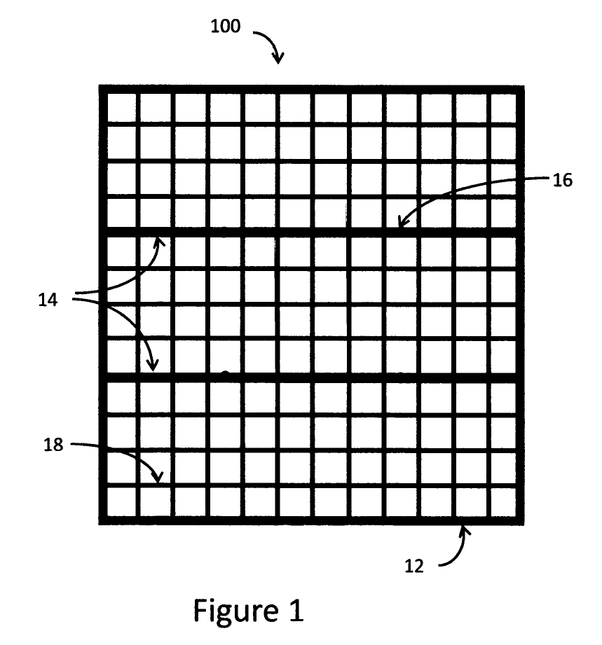

The planar grid 100 shown in FIG. 1 illustrates a square frame 12 constructed from wood, stainless steel, PVC piping or other lightweight rigid material. In one common application the frame 12 is 30 inches on a side. In another common application the frame 12 is 24 inches on a side. The frame includes two additional cross members 14 containing inlets or holes 16 where vertical supports can feed through and easily slide. Metal trellis wire or string 18 is also attached to the frame in two perpendicular directions. The wire or string form a grid in which the spacing is wide enough for plant stalks to pass through yet narrow enough to provide support for the plant. In one common application the grid spacing is approximately 2 inches. The plant stalks branches and leaves are feed through the grid at locations that provide support and space out the branches to maximize light exposure. Alternatively the planar grid is placed above the plant and the plant is allowed to grow through the grid so that later in the plant's life the stalks are supported by the trellis. In particular for indoor grow environments, the light is often provided by special grow lamps that can be expensive to purchase and maintain and these lamps typically consume large amounts of electrical power. For this reason the placement of the plant leaves should be optimized. This invention directs plant and leaf placement holds them in place.

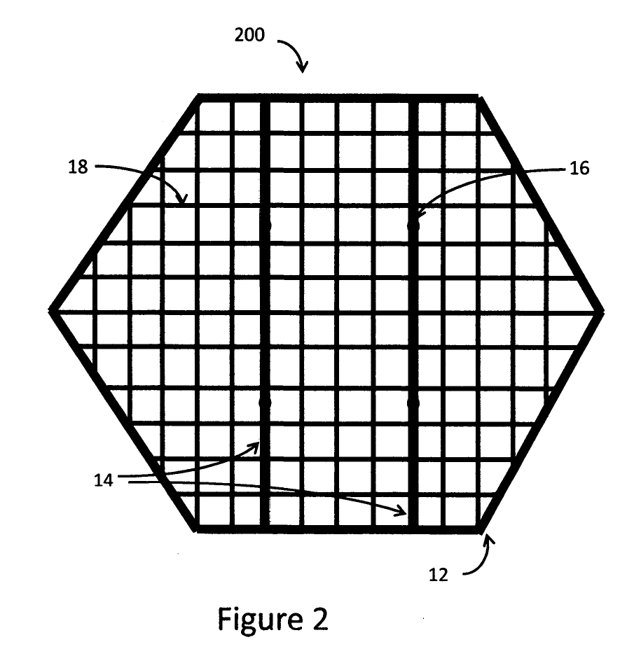

The planar grid 200 shown in FIG. 2 contains a hexagon shaped frame as an alternate to the square shaped frame shown in FIG. 1. Frame 12, cross members 14, holes 16, and trellis wire 18 are included. One skilled in the art can easily contemplate other shapes for the grid frame assembly such as pentagon, octagon and circular frame shapes.

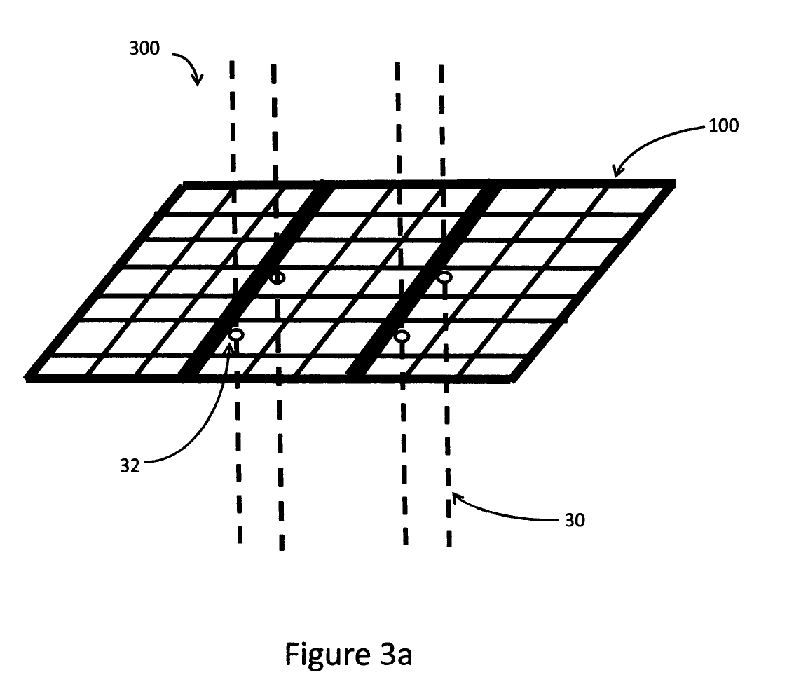

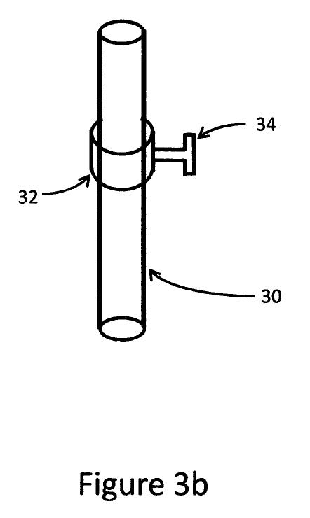

FIG. 3a contains a three dimensional illustration view 300 showing grid frame assembly 100 from FIG. 1 and vertical support stakes 30. Support stakes can be constructed from wood, PVC piping or metal with a size small enough to fit through inlet holes 16 in grid cross member. Support clips 32 are attached to stakes 30 directly under the grid frame to hold it in place. In one application vertical support stakes are constructed from ¼ inch diameter steel core plastic rods.

FIG. 3b is a magnified view of support clips 32 attached to vertical support stakes 30. Clips 32 are shown here as donut shaped hardware with set screw 34 to hold in place. These clips can also be made from binder clips, shop clamps or other such hardware.

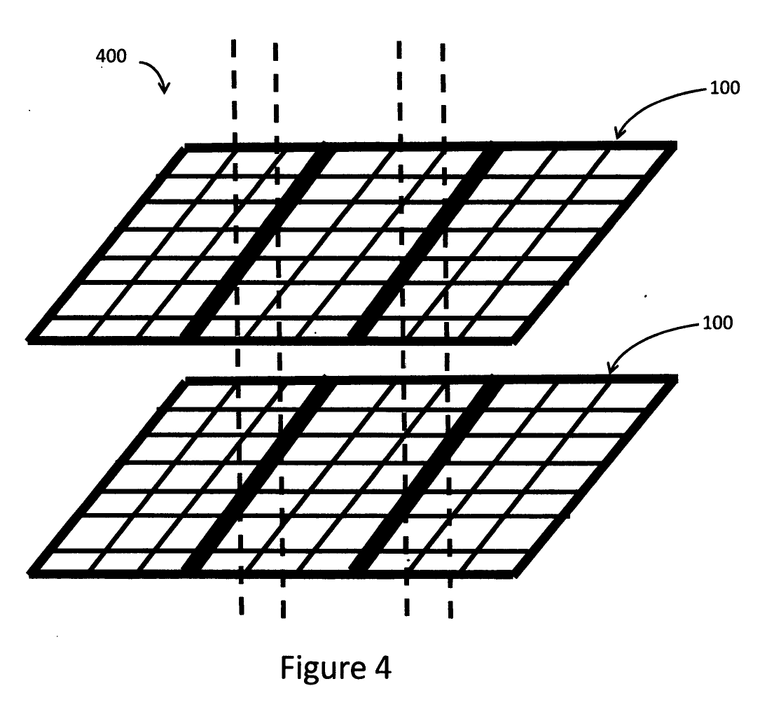

FIG. 4 contains a three dimensional illustration view 400 showing two grid frame assemblies 100 for additional plant support and spreading control. Those skilled in the relevant art recognize that there are many acceptable variations in design of this plant trellis structure which will not alter the essence of this invention. For example it is contemplated that if additional plant support of light/leaf placement optimization is desired three or more planar grids can be utilized.

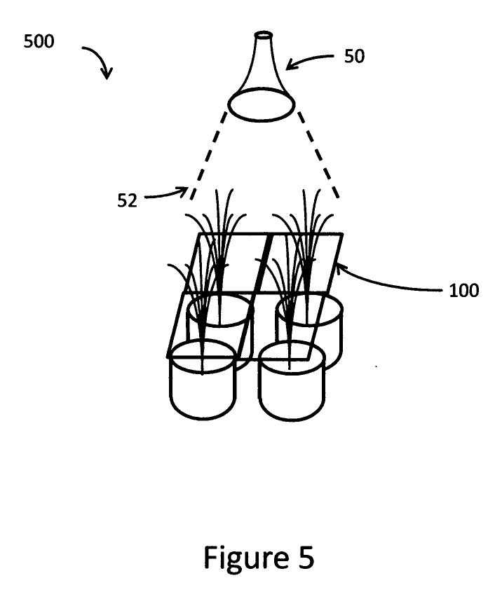

FIG. 5 contains complete plant, trellis and grow light setup 500. Lamp 50, has a focused light beam area 52 of 4 feet by 4 feet to 5 feet by 5 feet. Four trellis plant assemblies 100 are used together to maximize efficiency and plant growth.

The trellis assemblies shown here are designed for cannabis plants grown in inside grow house type environments but can be used for many other plant types in indoor as well as outdoor type environments.

While there have been described above the principles of the present invention in conjunction with a specific circuit and timing implementation it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known and which may be used instead of, or in addition to the features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features or combinations of such features during the prosecution of the present application or of any further application derived therefrom without departing from the spirit or scope of the present invention.

We claim:

1. A plant trellis structure comprising:
a horizontal planar grid attached to vertical stakes;
said planar grid comprising a rigid frame for holding a wire grid used to support plant stalks;
said rigid frame containing holes for vertical stakes;
said grid allowed to slide up and down along vertical stakes.

2. The plant trellis structure according to claim 1 where minimum height adjustment of said horizontal grid is accomplished with clamps.

3. The plant trellis structure according to claim 2 where the number of said vertical stakes is four.

4. The plant trellis structure according to claim 2 where said rigid frame is square in shape.

5. The plant trellis structure according to claim 2 where said rigid frame is circle in shape.

6. The plant trellis structure according to claim 2 where plants are held spread apart to a 5 foot by 5 foot area for optimal light exposure.

7. The plant trellis structure according to claim 2 where plants are held spread apart to a 4 foot by 4 foot area for optimal light exposure.

8. The plant trellis structure according to claim 2 where said rigid frame includes two additional cross member supports with holes for vertical stakes.

9. A plant trellis structure comprising:
multiple horizontal planar grids attached to vertical stakes;
said planar grids comprising a rigid frame for holding a wire grid used to support plant stalks;
said rigid frame containing holes for vertical stakes;
said grid allowed to slide up and down along vertical stakes.

10. The plant trellis structure according to claim 9 where said planar grids are two in number.

11. A method of operating a plant trellis support system comprising:
raising or lowering grid framework along vertical stakes for optimum height;
spreading wire mesh to allow stalks, branches and leaves to pass through to set height;
reducing wire mesh spacing to provide support to plant stalks.

12. The method of operating a plant trellis according to claim 11 wherein said optimum height maximizes exposure to a 5 foot by 5 foot illumination system.

13. The method of operating a plant trellis according to claim 11 wherein said optimum height maximizes exposure to a 4 foot by 4 foot illumination system.

14. The method of operating a plant trellis according to claim 11 wherein said grid framework is doubled or tripled to allow additional support for taller plants.

15. The method of operating a plant trellis according to claim 11 wherein minimum height adjustment of said horizontal grids is accomplished with placing clamps under said horizontal grids on said vertical stakes.

16. The method of operating a plant trellis according to claim 11 further comprising spreading plant stalks with horizontal grid to a 5 foot by 5 foot area.

17. The method of operating a plant trellis according to claim 11 further comprising spreading plant stalks with horizontal grid to a 4 foot by 4 foot area.
